(19) United States
(12) Patent Application Publication
(10) Pub. No.: US 2005/0150777 A1
(43) Pub. Date: Jul. 14, 2005

(54) Method and system for material removal and planarization

(76) Inventor: Bulent M. Basol, Manhattan Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/011,529

(22) Filed: Nov. 19, 2004

Related U.S. Application Data
(60) Provisional application No. 60/524,119, filed on Nov. 21, 2003.

(51) Int. Cl. B23H 5/00

(52) U.S. Cl. 205/668

(57) ABSTRACT

A system and method for removal and planarization of conductive material on a semiconductor substrate using an electrode contacting a solution. Physical contact is established between the conductive material and the solution. A buffer layer on the conductive material is formed by varying the temperature of the conductive material. A potential difference is applied between the conductive material and the electrode and the buffer layer is removed from raised regions of the conductive material by electropolishing the raised regions with the solution while the recessed regions of the conductive material are covered by the buffer layer.

### RELATED APPLICATIONS

This application claims priority to U.S. Provisional Application No. 60/524,119, filed Nov. 21, 2003.

### FIELD

The present invention relates generally to the manufacture of semiconductor integrated circuits and, more particularly, to a method for electropolishing or polishing of conductive layers for planarization and removal.

### BACKGROUND

Conventional semiconductor devices generally include a semiconductor substrate, which is typically a silicon substrate, and a plurality of sequentially formed dielectric interlayers, such as silicon dioxide, and conductive paths or interconnects made of conductive materials. Copper and copper alloys have recently received considerable attention as interconnect materials because of their superior electromigration and low resistivity characteristics. Interconnects are usually formed using a deposition process, filling copper in features or cavities etched into the dielectric interlayers. Although Physical Vapor Deposition (PVD) and Chemical Vapor Deposition (CVD) techniques may be used, the preferred method of copper deposition is typically electroplating. In an integrated circuit, multiple levels of interconnect networks laterally extend with respect to the substrate surface. Interconnects formed in sequential interlayers can be electrically connected using vias or contacts.

In a typical process, an insulating dielectric interlayer is first formed on a semiconductor substrate. Patterning and etching processes are then performed to form features, such as trenches and vias, in the insulating layer. The insulating layer is lined with a barrier layer. Then, copper is electroplated to fill all the features. However, the plating process results in a thick copper layer on the substrate. Some of the copper layer needs to be removed before the subsequent step. Conventionally, after the copper plating, a CMP process is employed to planarize and then reduce the thickness of the copper layer down to the level of the surface of the barrier layer first and then to insulating layer. In summary, CMP is used to remove all of the copper from the upper surface of the insulator so that copper-filled features are electrically isolated from one another.

However, CMP is a costly and time-consuming process that reduces production efficiency. Furthermore, although CMP can be used with conventional interlayer dielectrics, it may create problems with low-k dielectrics because of the high mechanical force applied to the substrate surface during the CMP process. During the CMP step, low-k materials may be stressed and may delaminate or other defects may form due to the low mechanical strength of the low-k materials.

Another material removal technique involves well-known electropolishing processes. In electropolishing, which may also be referred to as electrochemical etching or electroetching, the material to be removed and an electrode are both exposed to electro-polishing solution. Typically, an anodic (positive) voltage is applied to the material to be removed with respect to the conductive electrode. With the applied voltage, the material is electrochemically dissolved and removed from the substrate surface. However, this technology has a limited use in planarizing non-flat and non-uniform copper layers because during electroetching, material removal generally progresses in a conformal manner. The conformal nature of the process produces dishing defects in large features with small aspect ratios, which adversely affects wire dimensions and causes defects during fabrication of multi-layers of interconnects.

FIG. 1 illustrates conformal removal of a copper layer 10, which is deposited to fill features 14, 16 and 18. As shown in FIG. 1, features 14, 16 and 18 are etched in a dielectric layer 20 that is formed on the substrate 21. The features 14, 16, 18 and the surface of the dielectric 20 are typically lined with a barrier layer 22, such as a tantalum (Ta) or tantalum nitride (TaN) layer, and with a copper seed layer 24 before copper deposition. In FIG. 1, features 14 and 16 exemplify narrow trenches or vias having an aspect ratio of greater than 1. Feature 18 exemplifies a large trench with an aspect ratio of much less than 1. The aspect ratio is a ratio of the depth of the trench to the width of the trench.

As shown in FIG. 1, conventional electrodeposition processes fill the narrow features 14, 16 in a bottom-up fashion and thus yield a nearly flat surface over such features. However, copper deposits conformally in the large features 18 and forms recesses or steps over them. In this respect, electroetching of the copper layer 10 also progresses conformally during the standard electroetching process, as shown in FIG. 1 by dotted lines 26, 28, which represent the progressively etched surface of the copper layer 10. As the etching of the copper layer 10 progresses, the top surface of the copper layer 10 gradually approaches the features 14, 16, 18. When the etched surface 28 is reached, some remains over the field regions, but the copper in large feature 18 is over etched, resulting in dishing, as shown in FIG. 1.

Dishing problems originating from the conformal nature of the electroetching process may be alleviated by using methods that partially planarize the thick layer by employing, for example, CMP or another known planarization technique prior to the electroetching step. In such approaches, once the excess layer is made flat, the resulting flat surface is then uniformly etched back down to the barrier layer. However, such multi-process approaches are cumbersome and time consuming. Besides, success of such multi-process approaches depends on the thickness uniformity of the flat layer to which the electroetching process is applied. If the copper layer has slight local or global thickness non-uniformities, i.e., thinner and thicker areas, the features under the thinner copper layer will most likely be dished while the thicker copper layer is still being removed from other areas on the wafer. Such non-uniformities can be the result of various reasons, such as copper plating tool design, plating chemistry problems, problems with electrical contact to the wafer, plating solution problems, and the like. Alternatively, there may be non-uniformities in the electroetching process itself that may cause non-uniform material removal from various parts of the substrate.

As described above, due to the non-planarity and thickness non-uniformities of the copper layer, conventional electroetching processes either over etch the copper in all of the features or over etch it in some of features while planarizing it over other features. A process that slows down or stops etching of the areas that begins to dish but accelerates etching of the un-etched areas would overcome the above-described drawbacks.

Certain variations of the electroetching process attempt to alleviate such process drawbacks. In one technique, for example, the recesses or low points are filled or masked with a material having low ionic conductivity and low diffusivity before the substrate is placed into the electroetching system. Use of such material coating on the substrate surface is said to slow down the etching of the recess areas during electroetching, and helps to planarize the copper layer. However, such approaches require additional process steps and the introduction of new chemical species with low ionic conductivity from the substrate into the electropolishing chemistry. Such additional steps may, in time, negatively impact the effectiveness of the electropolishing solution, especially if, for cost savings, the solution is recycled continuously during the processing of a multiplicity of wafers in a production environment.

To this end, there is a need for alternative etching techniques that etch back even highly non-uniform conductive films with greater efficiency and without contaminating the process solution and those that do not cause excessive dishing into the features.

### SUMMARY

In accordance with one aspect of the invention, a method is provided for planarizing a conductive surface of a substrate using a solution and an electrode contacting the solution. The conductive surface includes raised regions and recessed regions. Physical contact is established between the conductive surface and the solution. A buffer layer is formed over the conductive surface by varying a temperature of the conductive surface. A potential difference is applied between the conductive surface and the electrode, and at least a portion the buffer layer is removed from the raised regions to electropolish the raised regions with the solution.

In accordance with another aspect of the invention, a system is provided for planarizing a conductive surface on a substrate using a solution. The conductive surface includes recessed regions and raised regions. The system comprises a carrier, a cooling mechanism, and a pad. The carrier is configured to hold the substrate in contact with the solution. The cooling mechanism is attached to the carrier, and is capable of lowering a temperature of the conductive surface to form a buffer layer over the conductive surface. The pad is configured to remove at least a portion of the buffer layer from the raised regions to electropolish the raised regions.

In accordance with yet another aspect of the invention, a method is provided for planarizing a conductive surface of a substrate using a solution. The conductive surface includes raised regions and recessed regions. Physical contact is established between the conductive surface and the solution. A buffer layer is formed over the conductive surface. The buffer layer may be formed by varying a temperature of the conductive surface, and at least a portion of the buffer layer is differentially disturbed from the raised regions to polish the raised regions with the solution.

### BRIEF DESCRIPTION OF THE DRAWINGS

These and other aspects of the invention will be readily apparent to the skilled artisan in view of the description below, the appended claims, and from the drawings, which are intended to illustrate and not to limit the invention, and wherein:

FIG. 1 is a schematic side view of a non-planar conductive layer on a substrate that is electroetched using a conventional electroetching process;

FIG. 2 is a schematic side view of a non-planar conductive layer on a substrate immersed in electropolishing solution according to an embodiment;

FIG. 3 is a schematic side view of the substrate shown in FIG. 2, wherein a buffer layer has been formed on the conductive layer;

FIG. 4 is a schematic side view of the substrate shown in FIG. 3 showing removal of portions of the buffer layer;

FIG. 5 is a schematic side view of the substrate shown in FIG. 3, wherein raised regions of the conductive layer are electropolished;

FIG. 6 is a schematic side view of the substrate shown in FIG. 5, wherein the conductive layer has been planarized; and

FIG. 7 is a schematic side view of the substrate shown in FIG. 5, wherein the planarized conductive layer has been removed from over the top surface of the insulator.

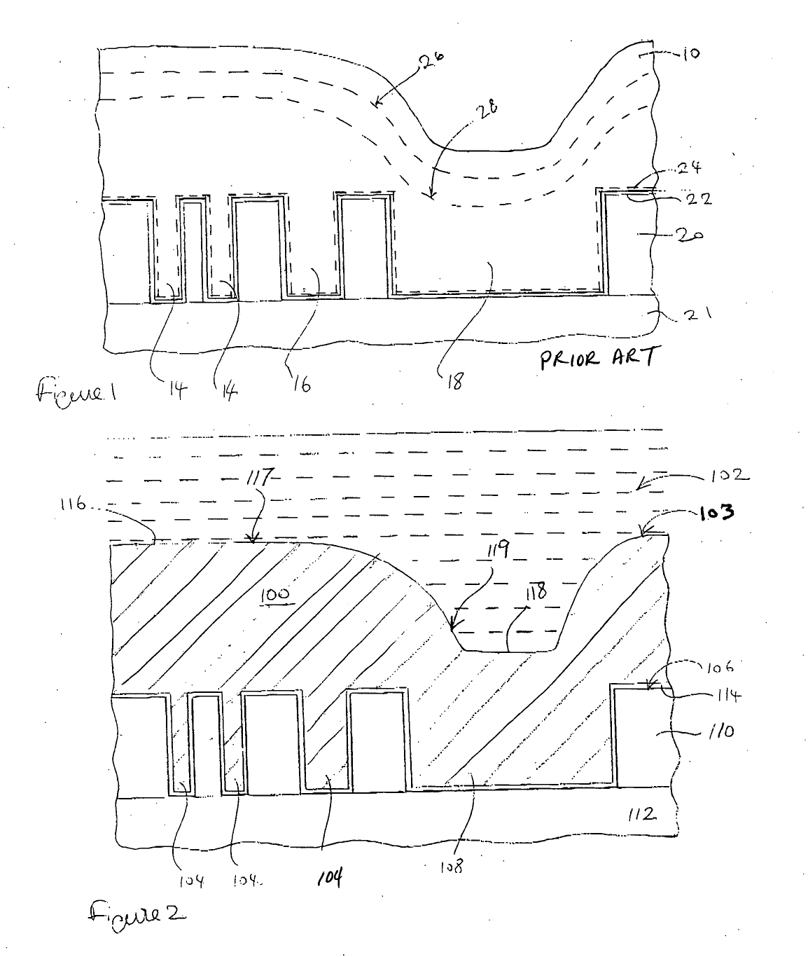

### DETAILED DESCRIPTION

The following detailed description of the preferred embodiments and methods presents a description of certain specific embodiments to assist in understanding the claims. However, one may practice the present invention in a multitude of different embodiments and methods as defined and covered by the claims.

It will be appreciated that the apparatuses may vary as to configuration and as to details of the parts, and that the methods may vary as to the specific steps and sequence, without departing from the basic concepts as disclosed herein.

In accordance with embodiments of the present invention, a buffer layer is formed over a conductive surface of a substrate having non-planar topography. Although the buffer layer is formed over the surface of the conductive surface in the illustrated embodiment described below, it will be understood that the buffer layer may be formed only in recessed regions.

According to an embodiment, an electropolishing process uses a multi-phase process environment in combination with a mechanical influence to electropolish a conductive surface of a workpiece. In one preferred embodiment, the multi-phase process environment is comprised of a dual phase process environment having an etchant phase and a buffer phase. In the preferred embodiment, the etchant phase is an electropolishing solution for electroetching the conductive surface, and the buffer phase is a gel phase or a viscous phase for slowing down or stopping the etching action of the electropolishing solution.

In an initial step of the process, the gel phase is formed in-situ between the conductive surface and the electropolishing solution when the conductive surface of the workpiece is cooled down to a predetermined temperature range. In other words, the gel phase is not the gel phase of a foreign matter that may eventually contaminate the process solution, but it is the gel phase of the electropolishing solution itself.

Once formed on the conductive surface, the gel phase acts as a barrier and slows down or altogether stops electropolishing action that is applied by the electropolishing solution. In a second step of the process, the electropolishing of the conductive surface is provided by mechanically disturbing the gel phase on the conductive surface and exposing the conductive surface to the electropolishing solution for a short time. The mechanical disturbance may be a sweeping action that is applied by a sweeper tool sweeping the conductive surface by physically contacting the conductive surface. The sweeper tool substantially removes the gel phase from the conductive surface when physical contact occurs and enables the electropolishing solution to act on the exposed surface. As the mechanical disturbance applied by the sweeper diminishes, the gel layer is again formed on the conductive surface and stops the etching of the conductive surface.

If the conductive surface is a non-planar layer having raised and recessed regions, the sweeping action can be configured to differentially, selectively remove the gel phase on the raised portions of the conductive layer but not the gel phase covering the recessed regions. In this respect, as the process progresses, initially, the raised portions of the conductive layer are exposed to the electropolishing solution because the sweeper can touch the raised portions. Since the sweeper cannot sweep the surface of the recessed portions, the recessed portions are not electropolished as much or are not electropolished at all during the electropolishing of the raised surfaces. Repeated mechanical action reduces the thickness of the raised portions while making the recessed portions smaller and smaller. If the sweeping is applied rapidly, a gel layer may not form on the raised portions but a gel layer forms only within the recessed portions where the sweeping action is not as effective.

Once the conductive surface is planarized, the removal process uniformly proceeds until the desired conductive layer thickness is obtained. Alternatively, the entire excess conductive layer is removed from the upper surface of the insulator, leaving conductive material only in the features or cavities. Although embodiments can be used to electropolish many different conductive materials, copper electropolishing according to a preferred embodiment will be described in more detail below.

Reference will now be made to the drawings in which like numerals refer to like parts throughout. FIG. 2 shows a copper material layer 100 contacting a liquid phase 102 or electropolishing solution. In this embodiment, the electropolishing solution 102 is preferably a phosphoric acid and glycerol mixture. An exemplary electropolishing solution may include 50% phosphoric acid and 50% glycerol.

As shown in FIG. 2, the surface 103 of the copper layer 100 is a non-uniform or non-flat surface with topography. The copper layer 100, formed over a dielectric layer 110, is a conformal layer, which fills the features 104, 108 or cavities formed in the dielectric layer 110. The dielectric layer 110 is formed on a semiconductor substrate 112. The substrate 112, with the above described structure formed over it, exemplifies a portion of a semiconductor wafer or a workpiece. Typically, other features, including, but not limited to, transistors, capacitors, resistors, and local interconnects, are located between the workpiece and the copper. During the electropolishing process, the workpiece may be held by a workpiece carrier, which may rotate or move the workpiece.

As shown in FIG. 2, a barrier layer 114 coats the surface 106 of the dielectric and the features 104,108. As shown in FIG. 2, a raised portion 116 of the copper layer 100 is located over the narrower features 104, which may be vias or narrow trenches. The raised portion 116 may have a surface 117, which has a nearly flat or convex profile resulting from the bottom up filling of the features 104. The surface 117 of the raised portion 116 will be referred to as the raised surface hereinafter. A recessed portion 118 of the copper layer 100, on the other hand, is located over the large trench 108. The recessed portion 118 may have a surface 119 having a concave profile resulting from the conformal filling of the large trench 108. The surface 119 of the recessed portion 118 will be referred to as the recessed surface hereinafter.

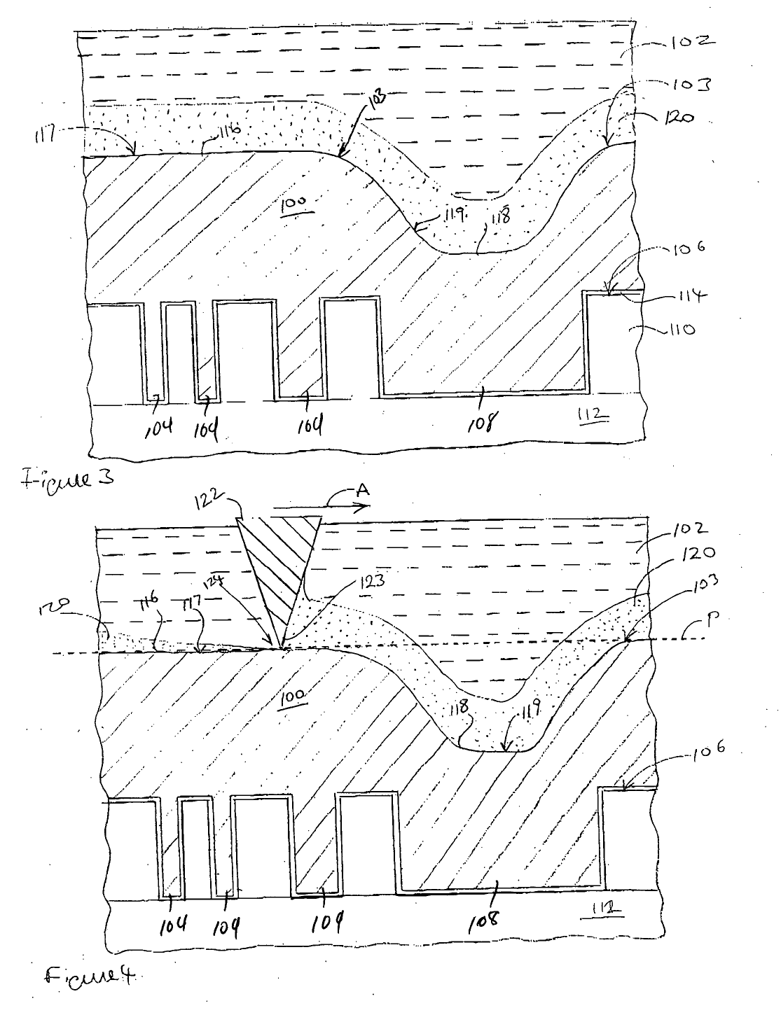

As illustrated in FIG. 3, in accordance with an embodiment, electrochemical polishing of the copper layer 100 begins with forming a buffer layer selected to slow electropolishing. In the illustrated embodiment, the buffer layer is a gel phase or gel layer 120 on the surface 103 of the copper layer 100 by changing the temperature of the surface 103. In this embodiment, the gel layer 120 is formed by lowering the temperature of the copper layer 100, preferably to a predetermined temperature range of −10 to 10° C. As the temperature of the copper layer 100 is cooled down to this predetermined temperature range, the electropolishing solution 102 covering the surface 103 begins to transform into a viscous state and forms the gel layer 120. The gel layer 120 may be kept on the surface 103 of the copper layer 100 as long as the temperature of the copper layer 100 is kept within the predetermined temperature range. The thickness of the gel layer 120 may be varied by varying the temperature of the copper layer 100 or the substrate 112. It will be appreciated that the thickness of the gel layer 120 will be greater for lower temperatures. In one embodiment, the cooling of the substrate 112 and the copper layer 110 on it is provided by the workpiece carrier that is holding the substrate 112 during the process. The substrate 112 may be cooled down by a cooling system attached to the wafer head of the workpiece carrier, which lowers the temperature of a carrier head section on which the substrate 112 is held, for example, chuck face, on which the wafer is placed.

It will be understood that the gel layer 120 only forms at the interface of the electropolishing solution 102 and the surface 103, since the temperature of the electropolishing solution is higher, for example, 20° C. or higher. This local cooling of the solution right at the surface 103 of the copper layer 100 allows coverage of the surface 103 with a thin gel layer 120. The thickness of the gel layer 120 can be controlled by process parameters, such as the substrate surface 103 temperature, flow rate of the electropolishing solution 102, rotation speed of the substrate, and the temperature of the electropolishing solution 102 that is brought in contact with the copper surface 103. As described above, the gel layer 120 forms locally on the surface 103 of the copper layer 100 and prevents or reduces the effectiveness of the electropolishing solution to etch the underlying copper layer 100. Lowering the temperature increases the viscosity of the process solution 102 on the surface 103. Increasing viscosity reduces diffusivity of the species that are responsible for polishing through the gel 120 and drastically reduces or stops material removal from the surface 103. These species include copper ions or complexes, phosphate ions and acceptor species, such as water. Additionally, for phosphorous acid based electropolishing solutions, it is well known that removal rate reduces with reduced temperature.

According to embodiments, the buffer layer, or gel layer 120 in the illustrated embodiment, is selectively or differentially removed or thinned over the raised regions 116. In the illustrated embodiment described below, portions of the gel layer 120 are physically disturbed. FIG. 4 illustrates an application of a sweeper 122 on the copper surface 103. As the sweeper 122 travels in direction A on a sweeping plane P, the sweeper 122 sweeps the raised surface 117 and removes the gel layer 120 in its path. In this respect, the sweeping plane P is kept substantially parallel to the top surface 106 of the dielectric layer to provide uniform material removal during the process. The sweeping plane P defines a plane at a predetermined elevation at which a contact end 123 of the sweeper moves. In a preferred embodiment, this elevation is constantly reduced, preferably automatically by the sweeper design, as the electropolishing progresses and the thickness of the raised portion 116 is reduced. The sweeping action may remove the buffer layer 120 completely or partially by reducing the thickness of it in the regions of the excess copper or raised portion 116. The sweeping action may only reduce the thickness of the buffer layer and electropolishing occurs as the thin buffer layer 120 covers the raised portions 116. It should be noted that although a specific sweeper 122 shape is shown in FIG. 4, various different shapes may be used. In an alternative embodiment, the sweeper 120 may be a planarization pad commonly used in CMP processes.

As the gel layer 120 is swept by the sweeper 122, an exposed surface section 124 of the raised surface 117 trails the sweeper 122 as the sweeper 122 moves in direction A. As the sweeper 122 exposes the exposed surface section 124, electroetching may occur in the exposed surface section 124 by the electropolishing solution 102, which is at a higher temperature than the gel 120. An exposed surface section 124 is a section of the raised surface 117 that is dynamically exposed by the sweeping sweeper 122 as it moves. Therefore, the exposed surface section 124 sweeps the raised surface 117 each time the sweeper scans the raised surface 117. The electropolishing solution 102 etches the exposed surface section 124 (at a significantly faster rate relative to etching through the gel layer 120) as soon as the gel layer 120 is removed from the copper surface 103. The etching action moves with the exposed surface section 124 and therefore the surface 117 is polished down uniformly, as the sweeper 122 travels along the raised surface 117. It is to be understood that the etching action on the exposed surface section 124 may take only a short time. The intensity of the etching is reduced as the gel layer 120 reforms on the exposed section 124. FIG. 4 shows the reforming of the gel layer 120 behind the advancing sweeper 122. By increasing the sweeping velocity, reforming of the gel layer 120 can be prevented, and the electropolishing rate can be increased. During electropolishing of the raised section 116, since the sweeper 122 moves on the sweeping plane P, the portion of the gel layer 120 remaining on the recessed surface 119 is not affected by the sweeping action and the gel layer 120 protects the underlying recessed surface 119 from being etched.

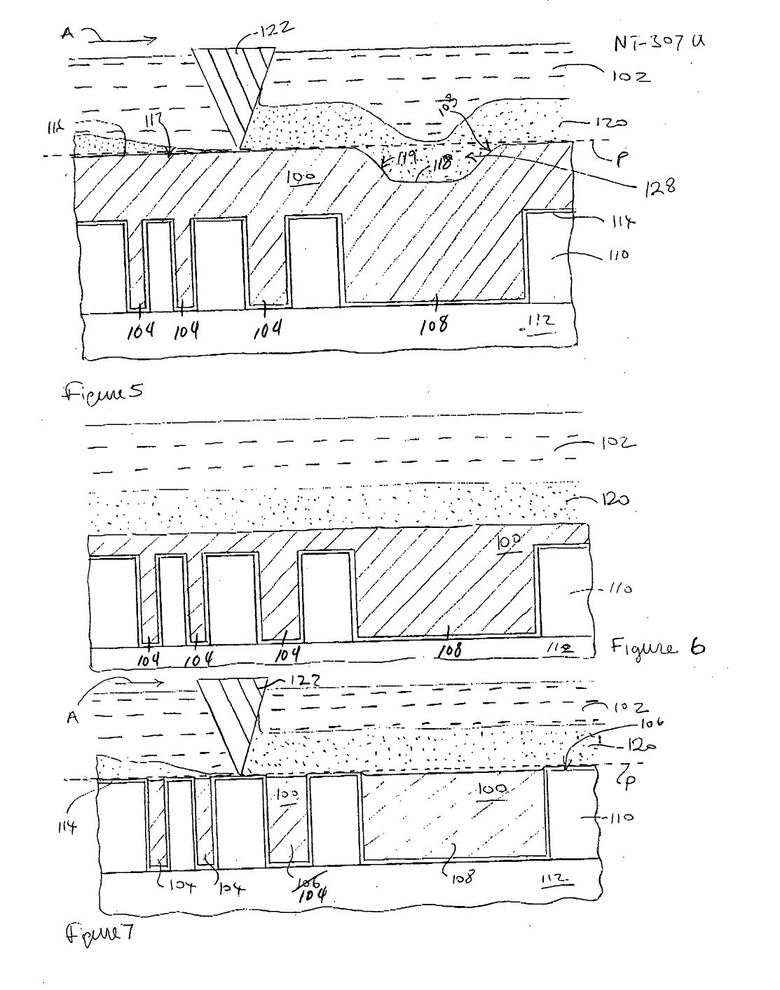

FIG. 5 illustrates an intermediate stage during the electropolishing process of an embodiment, where the planarity of the surface 103 is increased while both the thickness of the raised portion 116 and the surface area of the recessed surface 119 are reduced. The raised portion 116 is uniformly planarized down by the continuous sweeping action and the resulting etching action on the exposed surface section 124. As the material removal from the raised portion 116 progresses, material removal from the remaining surface area of the recessed surface 119 is prevented or slowed down by a plug portion 128 of the gel layer 120 that is not disturbed by the sweeping action because the plug portion 128 is under the sweeping plane P, as shown in FIG. 5. Although the plug portion 128 of the gel layer 120 gets smaller and smaller with the reduced thickness of the raised portion 116, it covers and protects the remaining surface area of the recessed surface 119 until the plug portion 128 is wiped off by the sweeper 122, which results in planarization of the copper layer 100, as shown in FIG. 6.

As shown in FIG. 7, the process may be continued to uniformly remove the copper layer 100 until the barrier layer 114 on the surface 106 of the dielectric layer 110 is exposed or an endpoint is reached. As the endpoint is reached, the copper layer 100 is confined in the features 104, 108 and forms planar deposits in the features 104, 108. The gel layer 120 protects the copper confined in the features 104, 108 and prevents any excessive dishing or copper removal from the surface of the copper in the features 104, 108.

In certain embodiments, the etching process described above may be performed in an electrochemical processing system. During the process, the workpiece is held by a workpiece carrier (not shown) so that the copper layer 100 is exposed to the process solution. The workpiece carrier can be rotated or laterally moved during the process while a potential difference is applied between the copper surface 103 and a cathode electrode of the system.

In other embodiments, the above described process may be performed in an electrochemical mechanical processing (ECMPR) system by anodically polarizing the copper layer 100, and using a workpiece surface influencing device as a sweeper 122. It will be understood that a relative motion between the copper layer 100 and the workpiece surface influencing device is preferably established to planarize the copper layer 100. The ECMPR process produces a planar copper layer on a substrate and descriptions of various ECMPR methods and apparatuses can be found in the following patents and pending applications: U.S. Pat. No. 6,176,992 entitled “Method and Apparatus for Electrochemical Mechanical Deposition,” U.S. Pat. No. 6,354,116 entitled “Plating Method and Apparatus that Creates a Differential Between Additive Disposed on a Top Surface and a Cavity Surface of a Workpiece Using an External Influence,” U.S. Pat. No. 6,471,847 entitled “Method for Forming Electrical Contact with a Semiconductor Substrate” and U.S. Pat. No. 6,610,190 entitled “Method and Apparatus for Electrodeposition of Uniform Film with Minimal Edge Exclusion on Substrate.” The entire disclosures of all of the foregoing patents are hereby incorporated herein by reference

In another embodiment, the same etching process steps may be performed as a chemical removal process, preferably using a sweeper. In a chemical removal process, no power is applied to the copper layer 100, and the etching is purely chemical. The chemical process may be performed using a chemical etchant, which can form a viscous layer on the copper layer 100 when the substrate temperature is lowered.

Although various preferred embodiments have been described in detail above, those skilled in the art will readily appreciate that the present invention extends beyond the specifically disclosed embodiments to other alternative embodiments and/or uses of the invention and obvious modification thereof without materially departing from the novel teachings and advantages of this invention. Thus, it is intended that the scope of the present invention herein disclosed should not be limited by the particular disclosed embodiments described above, but should be determined only by a fair reading of the claims that follow.

1. A method of planarizing a conductive surface of a substrate using a solution and an electrode contacting the solution, the conductive surface including raised regions and recessed regions, the method comprising:
establishing physical contact between the conductive surface and the solution;
forming a buffer layer over the conductive surface by varying a temperature of the conductive surface;
applying a potential difference between the conductive surface and the electrode; and
removing at least a portion the buffer layer from the raised regions to electropolish the raised regions with the solution.

2. The method of claim 1, wherein removing at least a portion of the buffer layer from the raised regions occurs while a portion of the buffer layer is covering the recessed regions.

3. The method of claim 1, wherein removing comprises reducing a thickness of at least a portion of the buffer layer.

4. The method of claim 1, wherein applying the potential difference makes the conductive surface an anode with respect to the electrode.

5. The method of claim 1, further comprising repeating removing and forming the buffer layer over the raised regions until a planar conductive layer is obtained.

6. The method of claim 5, further comprising reducing the thickness of the planar conductive surface.

7. The method of claim 1, wherein varying the temperature of the conductive surface comprises lowering the temperature of the conductive surface.

8. The method of claim 7, wherein lowering the temperature comprises lowering the temperature to a temperature range of −10° C. to 10° C.

9. The method of claim 1, wherein forming the buffer layer comprises forming a viscous phase of the solution on the conductive surface.

10. The method of claim 1, wherein removing the buffer layer from the raised regions is performed by a pad.

11. The method of claim 10, further comprising establishing a relative motion between the conductive surface and the pad.

12. The method of claim 11, wherein establishing the relative motion is performed by at least one of laterally moving the substrate and rotating the substrate.

13. The method of claim 1, wherein the conductive surface is made of copper.

14. An interconnect device manufactured including the method of claim 1.

15. A system for planarizing a conductive surface on a substrate using a solution, the conductive surface including recessed regions and raised regions, the system comprising:
a carrier configured to hold the substrate in contact with the solution;
a cooling mechanism attached to the carrier, the cooling mechanism capable of lowering a temperature of the conductive surface to form a buffer layer over the conductive surface; and
a pad configured to remove at least a portion of the buffer layer from the raised regions to polish the raised regions.

16. The system of claim 15, wherein the buffer layer is a viscous phase of the solution.

17. The system of claim 15, further comprising an electrode immersed in the solution.

18. The system of claim 15, further comprising a power supply configured to apply a potential difference between the electrode and the conductive surface.

19. The system of claim 15, further comprising a moving mechanism to establish a relative motion between the substrate and the pad.

20. The system of claim 15, wherein the solution is phosphoric acid solution.

21. The system of claim 15, wherein the conductive surface is copper.

22. The system of claim 15, wherein the buffer layer inhibits polishing of recessed regions while the raised regions are being polished.

23. A method of planarizing a conductive surface of a substrate using a solution, the conductive surface including raised regions and recessed regions, the method comprising:
establishing physical contact between the conductive surface and the solution;
forming a buffer layer over the conductive surface; and
differentially disturbing at least a portion of the buffer layer from the raised regions to polish the raised regions with the solution.

24. The method of claim 23, wherein forming a buffer layer is performed by varying a temperature of the conductive surface.

25. The method of claim 23, wherein differentially disturbing at least a portion of the buffer layer from the raised regions occurs while at least another portion of the buffer layer is covering the recessed regions.

26. The method of claim 23, further comprising repeating differentially disturbing and forming the buffer layer on the raised regions until a planar conductive layer is obtained.

27. The method of claim 23, wherein varying the temperature of the conductive surface comprises lowering the temperature of the conductive surface.

28. The method of claim 27, wherein lowering the temperature comprises lowering the temperature to a temperature range of −10° C. to 10° C.

29. The method of claim 27, further comprising reducing the thickness of the planar conductive surface.

30. The method of claim 23, wherein forming the buffer layer comprises forming a viscous phase of the solution over the conductive surface.

31. The method of claim 23, wherein differentially disturbing at least a portion of the buffer layer from the raised regions is performed by a pad.

32. The method of claim 30, wherein differentially disturbing comprises establishing a relative motion between the conductive surface and the pad.

33. The method of claim 31, wherein establishing the relative motion is performed by at least one of laterally moving the substrate and rotating the substrate.

34. The method of claim 23, wherein the conductive surface is copper.

35. An interconnect device manufactured including the method of claim 23.

36. A method of planarizing a nonplanar substrate having a conductive layer, comprising:
forming a buffer layer over the conductive layer in recessed regions of the substrate; and
selectively etching the conductive layer in regions in which the buffer layer is not formed over the conductive layer.
